(19) United States
(12) Patent Application Publication
(10) Pub. No.: US 2003/0174237 A1
(43) Pub. Date: Sep. 18, 2003

(54) Digital stereograph-capturing device

(75) Inventor: Te-Cheng Lee, Changhua (TW)

Correspondence Address: BROWDY AND NEIMARK, P.L.L.C., 624 NINTH STREET, NW, SUITE 300, WASHINGTON, DC, 20001-5303, US

(73) Assignee: Largan Digital Co., Ltd., Taichung (TW)

(21) Appl. No.: 10/196,221

(22) Filed: Jul. 17, 2002

(30) Foreign Application Priority Data
Mar. 15, 2002 (TW) 91203139

(51) Int. Cl. H04N 5/238

(52) U.S. Cl. 348/363

(57) ABSTRACT

A digital stereograph-capturing device is provided by the present invention including a first objective lens set and a second objective lens set adapted for receiving optical signals outside the stereograph-capturing device into said device, a shutter-switching unit, an image sensor, an image processor and a storage unit. The shutter-switching unit has a rotatable first reflecting mirror, a rotatable second reflecting mirror and a prism, thereby allowing only the pass of the optical signal received by the first objective lens set through said first reflecting mirror and the prism within an independent period of time, and allowing only the pass of the optical signal received by the second objective lens set through the second reflecting mirror and the prism within the other independent period of time. The image sensor is used to detect the optical signals passed through the shutter-switching unit. The image processor is used to transform the optical signals detected by the image sensor into corresponding digital signals. The storage unit saves the digital signals.

### FIELD OF THE INVENTION

The present invention relates to an image capture device, and more particularly to a digital stereograph-capturing device.

### BACKGROUND OF THE INVENTION

General stereograph capture mostly works to capture the optical signal of the same object under different optic angles, and photos may be presented a three-dimensional visual effect due to the parallax arising out of the optical signal corresponding to the object. Film in use consists of special chemical substances to enable the optical signal to be recorded on the same negative.

Conventional film used to record optical signal of the stereograph is costly. Generally speaking, the film requires to be processed minutes after being exposed, or chemical substances on the film will bring about changes that may not lead to image what one has expected.

### SUMMARY OF THE INVENTION

The primary objective of the present invention is to provide a digital stereograph-capturing device to achieve a low-cost and convenient employment of stereograph capture by means of a capture of the digital image data.

To achieve aforesaid objective, a digital stereograph-capturing device provided by the present invention comprises a first objective lens set and a second objective lens set adapted for receiving optical signals outside the stereograph-capturing device into said device, a shutter-switching unit, an image sensor, an image processor and a storage unit. The shutter-switching unit is capable of allowing only the pass of the optical signal received by the first objective lens set within an independent period of time, and allowing only the pass of the optical signal received by the second objective lens set within the other independent period of time. The image sensor is used to detect the optical signals passed through the shutter-switching unit. The image processor is used to transform the optical signals detected by the image sensor into corresponding digital signals. The storage unit saves the digital signals.

### BRIEF DESCRIPTION OF THE DRAWINGS

FIG. 1 is a schematic view of a first preferred embodiment of the present invention, showing the optical signal transmitted to the image sensor through the first objective lens set.

FIG. 2 is another schematic view of the first preferred embodiment of the present invention, showing the optical signal transmitted to the image sensor through the second objective lens set.

FIG. 3 is a schematic view of a second preferred embodiment of the present invention, showing the optical signal transmitted to the image sensor through the first objective lens set.

FIG. 4 is another schematic view of the second preferred embodiment of the present invention, showing the optical signal transmitted to the image sensor through the second objective lens set.

FIG. 5 is a schematic view of a third preferred embodiment of the present invention, showing the optical signal transmitted to the image sensor through the first objective lens set.

FIG. 6 is another schematic view of the third preferred embodiment of the present invention, showing the optical signal transmitted to the image sensor through the second objective lens set.

FIG. 7 shows an alternative structure of the third preferred embodiment of the present invention, demonstrating the shutter installed between the objective lens set and the reflecting mirror.

FIG. 8 is a schematic view of a fourth preferred embodiment of the present invention.

### DETAILED DESCRIPTION OF THE INVENTION

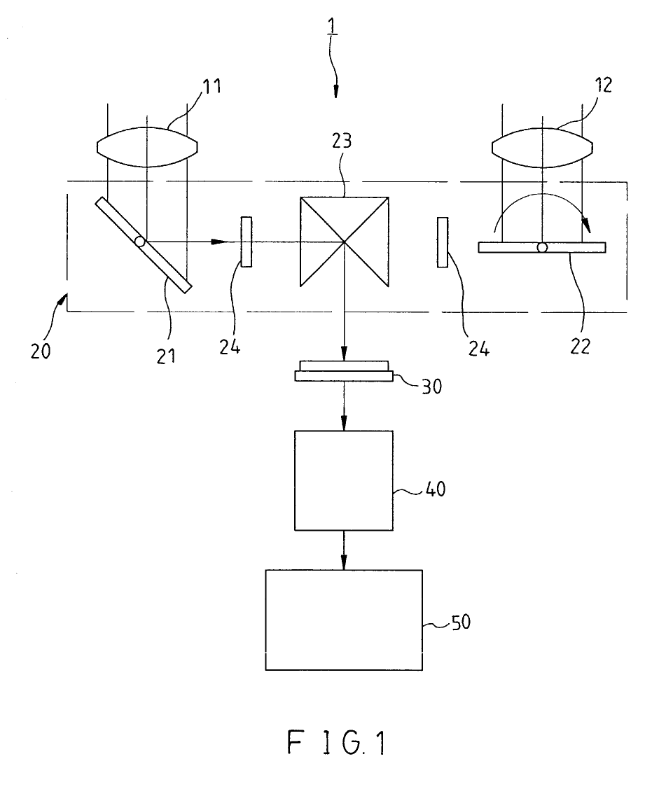

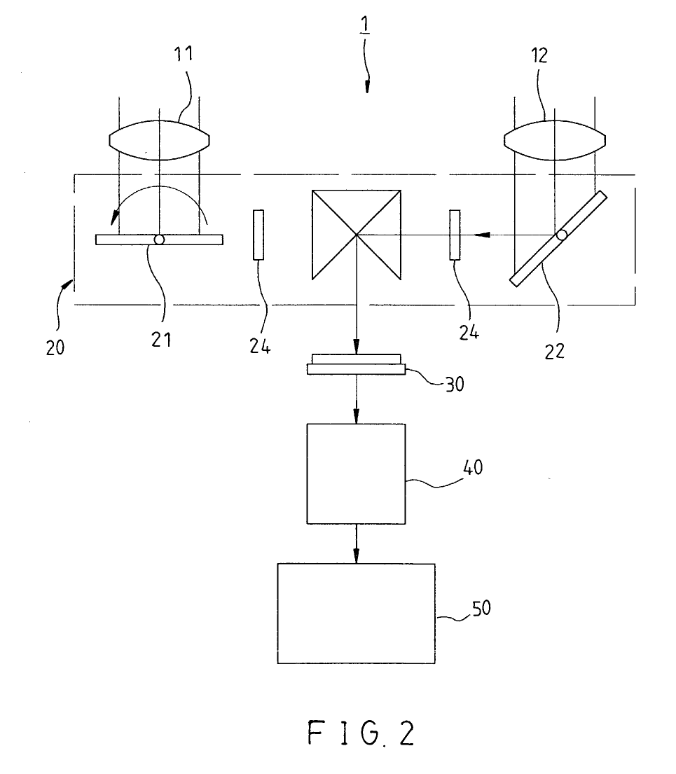

As shown in FIGS. 1 and 2, a digital stereograph-capturing device 1 provided by a first preferred embodiment of the present invention comprises a first objective lens set 11, a second objective lens set 12, a shutter-switching unit 20, an image sensor 30, an image processor 40, and a storage unit 50.

The first objective lens set 11 and second objective lens set 12 are arranged in parallel arrangement, enabling the outside optical signal to pass through. The first and second objective lens sets 11,12 comprise respectively at least one lens. However, only one convex lens is shown for one respective objective lens set in the drawings for easy illustration. The quantity, sequence and curvatures of lenses of each objective lens set are known art and not the main characteristics appertained to the present invention. Therefore, descriptions of these features are skipped.

The shutter-switching unit 20 has a first reflecting mirror 21, a second reflecting mirror 22, a prism 23 and two filters 24. The first reflecting mirror 21 is arranged behind the first objective lens set 11, and the second reflecting mirror 22 is arranged behind the second reflecting mirror 22. The prism 23 is disposed between the two reflecting mirrors 21, 22 and the two filters 24 are respectively disposed between the prism 23 and the respective reflecting mirrors 21,22.

Each of the two reflecting mirrors 21, 22 is able to be swiveled between a first position and a second position, and to be positioned at one of the positions. As shown in FIG. 1, the first reflecting mirror 21 is positioned at the first position and the second reflecting mirror 22 is positioned at the second position. FIG. 2 shows that the first reflecting mirror 21 is positioned at the second position and the second reflecting mirror 22 is positioned at the first position. When the first and second reflecting mirrors 21, 22 are respectively positioned at the first position, the posture of respective reflecting mirror is about a 45° slant corresponding to the respective objective lens sets, thus enabling the respective reflecting mirror to reflect the optical signals which pass through the respective objective lens sets and have them transmitted to the prism 23 which will have the optical signals reflected again and have them transmitted backwards. While each one of the reflecting mirrors 21, 22 being switched to the respective second position, the optical signals received by the objective lens sets 11, 12 will be reflected to other places, thus gaining no access to the prism 23.

The image sensor 30 is arranged behind the prism 23 and is used for detecting the optical signals reflected by the prism 23.

The image processor 40 is arranged behind the image sensor 30 and is sued to transform the optical signals detected by the image sensor 30 into the digital signals.

The storage unit 50 is electrically connected to said image processor 40 for saving the digital signals.

When the first reflecting mirror 21 is switched to the first position as the second mirror 22 switched to the second position, optical signal can only be received by the first objective lens set 11 and finally reaches the image sensor 30 after being reflected by the first reflecting mirror 21 and the prism 23, as shown in FIG. 1. Thereinafter, while the first reflecting mirror 21 is switched to the second position and the second reflecting mirror 22 switched to the first position, the other optical signal can only be received by the second objective lens set 21 and eventually reaches the image sensor 30 via the second reflecting mirror 22 and the prism 23, as shown in FIG. 2. The two optical signals are respectively transformed into the digital signals through the image processor 40, and eventually are saved in the target position of the storage unit 50.

In other words, the shutter-switching unit 20 works in: allowing the optical signal received by the first objective lens set 11 passing through the shutter-switching unit 20 to reach the image sensor 30 within an independent period of time, and on the other hand, also provided to allow the optical signal received by the second objective lens set 12 passing through the shutter-switching unit 20 to reach the image sensor 30 within the other independent period of time.

One point hereby required to be mentioned particularly is that switch of the two reflecting mirrors 21 22 is driven by a control device (not shown in drawings) which can be a gear-coupled or an electronic governor control. Initial position for the two reflecting mirrors 21, 22 is at the second one. While starting the shutter-switching unit 20, the first reflecting mirror 21 will switch to the first position while the second reflecting mirror 22 remains to stay at the second position as shown in FIG. 1. Optical signal as described earlier will be received by the first objective lens set 11 and detected by the image sensor 30. The control device will automatically drive the two reflecting mirrors 21, 22 to have them switched to the position, as what has shown in FIG. 2, after a short period. Consequently, the other optical signal can be received by the second objective lens set 12 and detected by the image sensor 30. In the end, the two reflecting mirrors 21, 22 go back to the second position and eventually complete one action of stereograph capture.

Consequently, the stereograph-capturing device 1 provided by the present invention may not be limited to the conventional stereograph-capturing system which features a limitation to film being processed shortly after the exposure, thus lowering cost to take stereograph and enabling the products to facilitate the marketing.

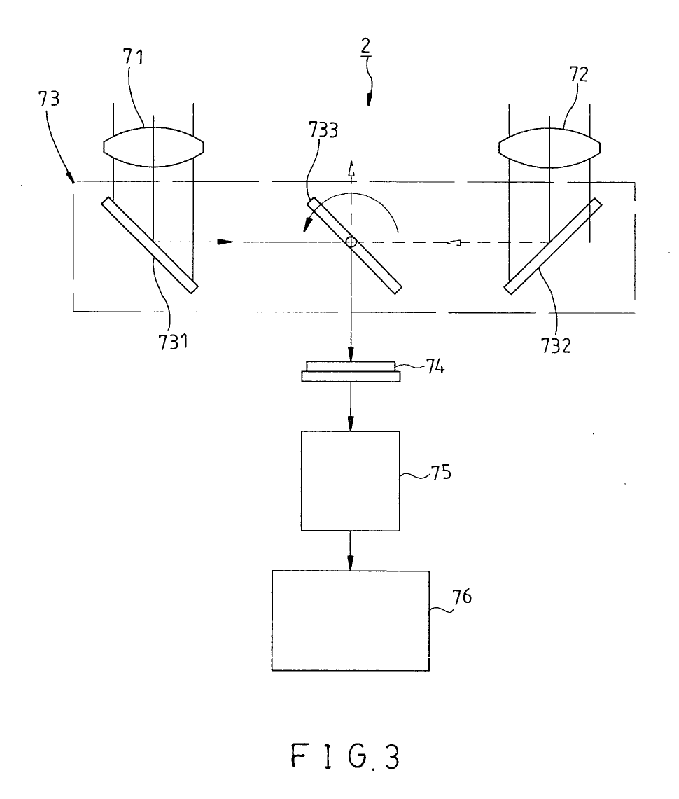

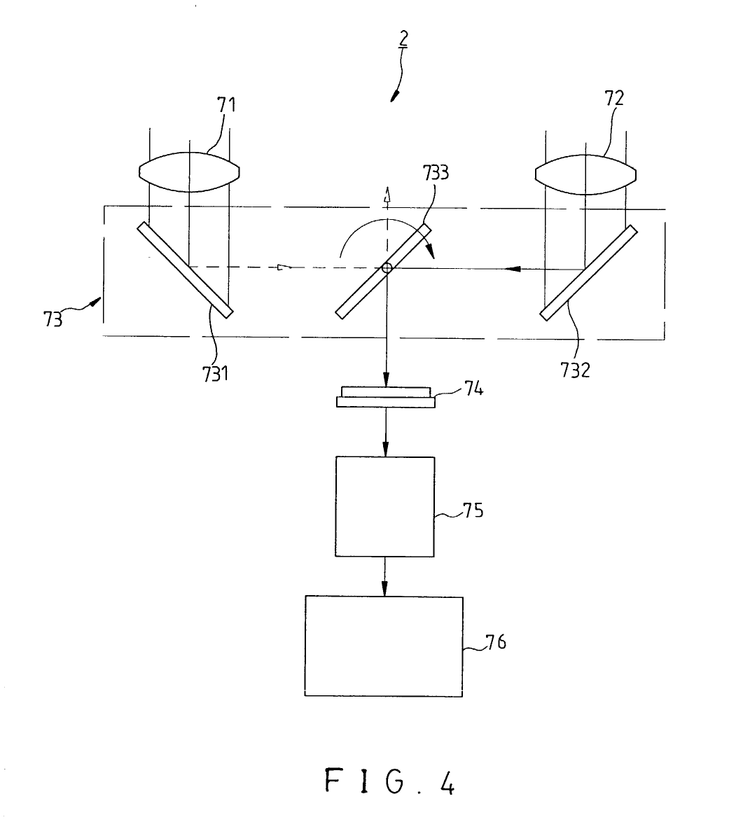

FIGS. 3 and 4 show the digital stereograph-capturing device 2 provided by the second preferred embodiment of the present invention that is similar to that one by the first preferred embodiment of the present invention, and it comprises a first objective lens set 71, a second objective lens set 72, a shutter-switching unit 73, an image sensor 74, an image processor 75 and a storage unit 76. The shutter-switching unit 73 has a first reflecting mirror 731, a second reflecting mirror 732 and an adjustable reflecting mirror 733. The two reflecting mirrors 731, 732 are immovable, and the adjustable reflecting mirror 733 is an element which its two faces are able to reflect rays and can make a switch between a first position and a second position as a result of a drive by a control device not shown.

When the adjustable reflecting mirror 733 is switched to the first position, as shown in FIG. 3, the optical signal received by the first objective lens set 71 can reach the image sensor 74 through the reflection from the adjustable reflecting mirror 733 after being reflected by the first reflecting mirror 731. At this moment, rays reflected by the second reflecting mirror 732 will be reflected to other places by the adjustable reflecting mirror 733 that may not gain an access to the image sensor 74.

On the contrary, the optical signals received by the second objective lens set 72 can reach the image sensor 74 through the reflection of the adjustable reflecting mirror 733 after being reflected by the second reflecting mirror 732. while the adjustable reflecting mirror 733 is switched to the second position, as shown in FIG. 4. At this time, rays reflected by the first reflecting mirror 731 will be reflected to other places by the adjustable reflecting mirror 733, thus being not be able to reach the image sensor 74.

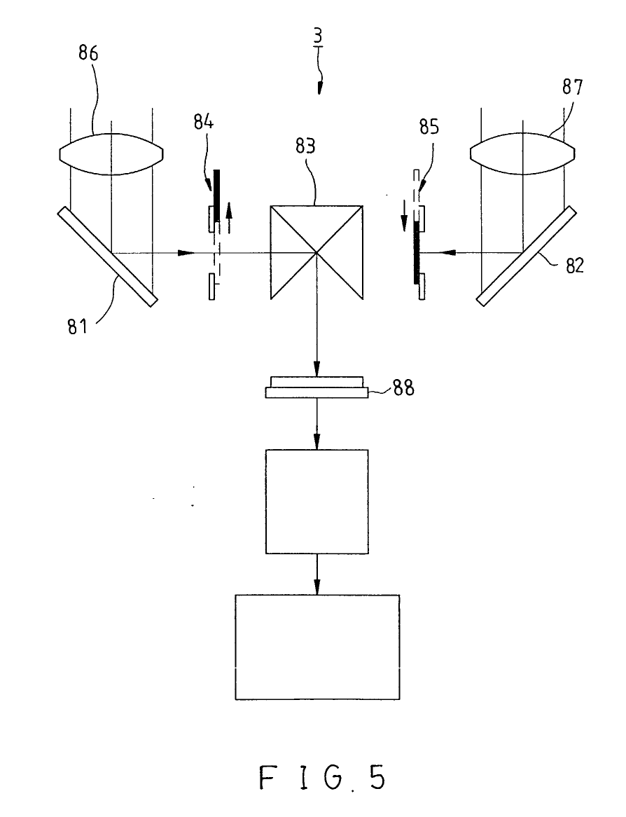

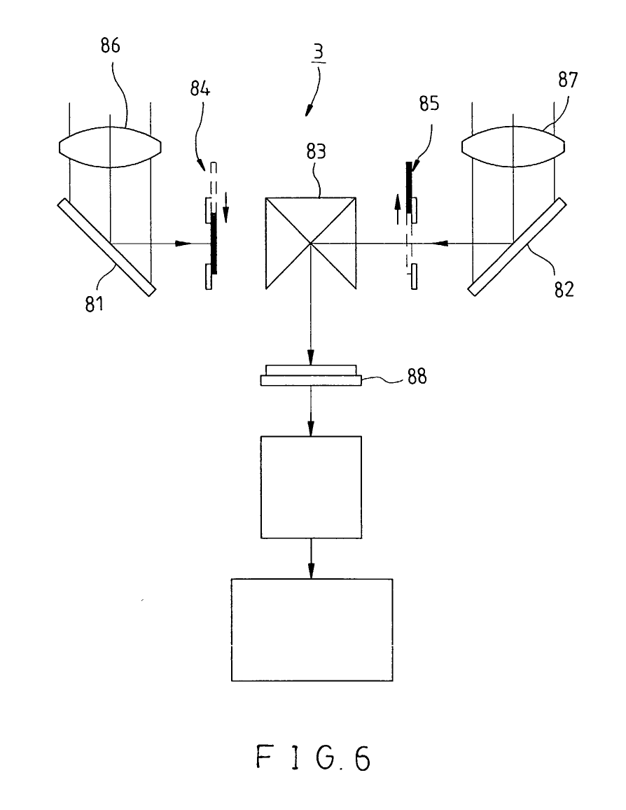

FIGS. 5 and 6 show the digital stereograph-capturing device 3 provided by the third preferred embodiment of the present invention while its main components are similar to ones provided by the first preferred embodiment, however, the first and the second reflecting mirrors 81, 82 are fixed and a first shutter 84 is disposed between the first reflecting mirror 82 and the prism 83 and a second shutter 85 is disposed between the second reflecting mirror 82 and the prism 83.

The two shutters 84, 85 are driven by way of a control device (not shown) and may remain in a closed condition under the initial status. While employing the device, the first shutter 84 will be opened first while the second shutter 85 remains to be closed. At the same time, the optical signal can only be received by the first objective lens set 86 and is then detected by the image sensor 88 through the first reflecting mirror 81, the first shutter 84 and prism 83. The optical signal received by the second objective lens set 87, however, may be intercepted by the second shutter 85, as shown in FIG. 5. Thereafter, the first shutter 84 is closed and the second shutter 85 is opened, while the image sensor 88 can merely detect the optical signal received by the second objective lens set 87, as shown in FIG. 6.

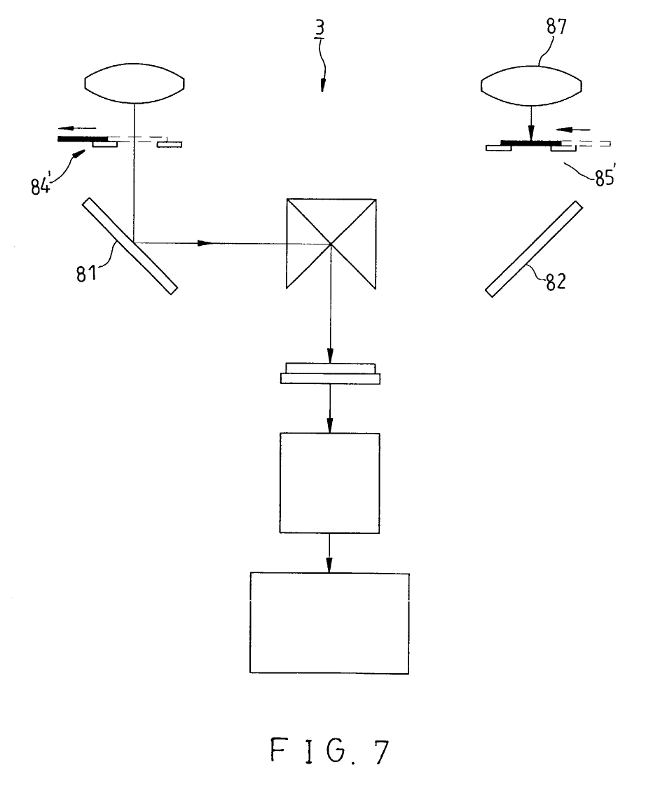

FIG. 7 shows two shutters 84′, 85′ to be disposed between the two objective lens sets 86, 87 and the two reflecting mirrors 81, 82, thus being able to achieve the same finctions as mentioned above.

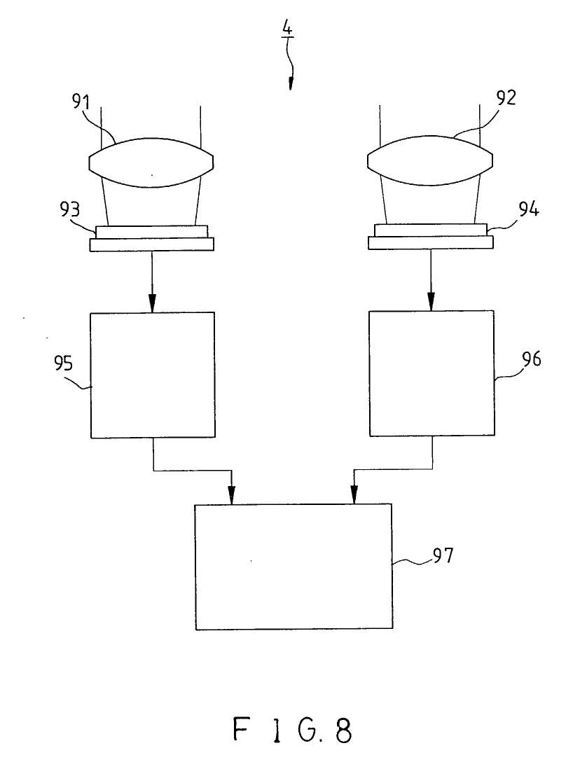

Please refer to FIG. 8, a digital stereograph-capturing device 4 provided by the fourth preferred embodiment of the present invention comprises a first objective lens set 91, a second objective lens set 92, a first and second image sensors 93, 94 disposed respectively behind the first and second objective lens sets 91, 92 for detecting optical signals passed respectively through the first and second objective lens sets 91, 92, a first and second image processors 95, 96 for receiving the optical signals detected respectively by the first and second image sensors 93, 94 and transforming the received optical signals into corresponding digital signals, and a storage unit 97 facilitating to save the digital signals produced by the first and the second image processors 95, 96.

According to this preferred embodiment, the aforesaid shutter-switching unit can be omitted to bring about a simpler operation on image capture by following structures illustrated above, but the same effectiveness still can be achieved.

What is claimed is:

1. A digital stereograph-capturing device comprising:
a first objective lens set and a second objective lens set adapted for receiving optical signals outside the stereograph-capturing device into said device;
a shutter-switching unit arranged behind the first and second objective lens sets and adapted for allowing only the optical signal received by the first objective lens set to pass through the shutter-switching unit within an independent period of time, and allowing only the optical signal received by the second objective lens set to pass through the shutter-switching unit within the other independent period of time;
an image sensor adapted for detecting the optical signals passed through the shutter-switching unit;
an image processor adapted for transforming the optical signals detected by the image sensor into corresponding digital signals; and
a storage unit adapted to save the digital signals.

2. The digital stereograph-capturing device as defined in claim 1, wherein said shutter-switching unit comprises a first reflecting mirror, a second reflecting mirror and a prism; wherein said first and second reflecting mirrors are disposed correspondingly to said first and second objective lens sets respectively and are actuated to swivel between a first position where the optical signals can be transmitted to said image sensor and a second position where the optical signals can not be transmitted to said image sensor, wherein the optical signal passed through said first objective lens set can be reflected to said prism by the first reflecting mirror and then be further reflected to said image sensor by said prism while the first reflecting mirror is swiveled to the first position, and the optical signals passed through said second objective lens set can be reflected to said prism by the second reflecting mirror and then be further reflected to said image sensor by said prism while the second reflecting mirror is swiveled to the first position.

3. The digital stereograph-capturing device as defined in claim 1, the shutter-switching unit comprises a first reflecting mirror, a second reflecting mirror and an adjustable reflecting mirror, wherein said first reflecting mirror is disposed correspondingly to the first objective lens set and adapted for reflecting the optical signal passed through said first objective lens set to said adjustable reflecting mirror, and said second reflecting mirror is disposed correspondingly to the second objective lens set and adapted for reflecting the optical signal passed through said second objective lens set to said adjustable reflecting mirror, wherein said adjustable reflecting mirror is actuated to swivel between a first position where the optical signal reflected from said first reflecting mirror can be further reflected to said image sensor by the adjustable reflecting mirror and a second position where the optical signal reflected from said second reflecting mirror can be further reflected to said image sensor by the adjustable reflecting mirror.

4. The digital stereograph-capturing device as defined in claim 1, wherein said shutter-switching unit comprises a first reflecting mirror, a second reflecting mirror, a first shutter, a second shutter and a prism, wherein said first reflecting mirror is disposed correspondingly to said first objective lens set and adapted for reflecting the optical signal passed through said first objective lens set to said prism, and said second reflecting mirror is disposed correspondingly to said second objective lens set and adapted for reflecting the optical signal passed through said second objective lens set to said prism, wherein said first shutter is arranged between the first reflecting mirror and the prism, and said second shutter is arranged between the second reflecting mirror and the prism.

5. The digital stereograph-capturing device as defined in claim 1, wherein said shutter-switching unit comprises a first reflecting mirror, a second reflecting mirror, a first shutter, a second shutter and a prism, wherein said first reflecting mirror is disposed correspondingly to said first objective lens set and adapted for reflecting the optical signal passed through said first objective lens set to said prism, and said second reflecting mirror is disposed correspondingly to said second objective lens set and adapted for reflecting the optical signal passed through said second objective lens set to said prism, wherein said first shutter is arranged between the first reflecting mirror and the first objective lens set, and said second shutter is arranged between the second reflecting mirror and the second objective lens set.

6. The digital stereograph-capturing device as defined in claim 1 further comprising a filter disposed in a transmitted path of the optical signal passed through said first objective lens set.

7. The digital stereograph-capturing device as defined in claim 6 further comprising an other filter disposed in a transmitted path of the optical signal passed through said second objective lens set.
